(19) United States
(12) Patent Application Publication
(10) Pub. No.: US 2026/0078794 A1
(43) Pub. Date: Mar. 19, 2026

(54) Reusable Nut Configured To Be Fixed Within Hole In Component And To Become Part Of Assembly With The Component

(71) Applicant: Newfrey LLC, New Britain, CT (US)

(72) Inventors: Luke STRUNK, Lake Orion, MI (US); Najwan RASSAM, Troy, MI (US); Bradley SMALL, West Bloomfield, MI (US); Jason A. MEYERS, Shelby Township, MI (US)

(73) Assignee: Newfrey LLC, New Britain, CT (US)

(21) Appl. No.: 19/395,925

(22) Filed: Nov. 20, 2025

Related U.S. Application Data
(63) Continuation-in-part of application No. PCT/US2024/038012, filed on Jul. 15, 2024.
(63) Continuation-in-part of application No. PCT/US2025/056324, filed on Nov. 20, 2025.
(60) Provisional application No. 63/527,270, filed on Jul. 17, 2023.
(60) Provisional application No. 63/722,867, filed on Nov. 20, 2024.

(51) Int. Cl. F16B 37/04

(52) U.S. Cl. CPC F16B 37/041

(57) ABSTRACT

A nut includes an inner body, an outer body, and a pair of arms. The arms connect the inner and outer bodies to one another while allowing the inner body to move relative to the outer body from a first position, in which a majority of the inner body is disposed outside of the outer body, to a second position, in which a majority of the inner body is disposed within the outer body. The inner body and the arms are insertable into a hole in a component when the inner body is in the first position and, when the inner body is moved from the first position to the second position after the arms are inserted through the hole, the arms deform radially outward such that a portion of the component surrounding the hole is captured between an annular flange on the outer body and the arms.

### CROSS-REFERENCE TO RELATED APPLICATIONS

This application is a bypass continuation-in-part of PCT International Application No. PCT/US2024/038012, filed on Jul. 15, 2024, which claims the benefit of U.S. Provisional Application No. 63/527,270, filed on Jul. 17, 2023. This application is a bypass continuation-in-part of PCT International Application No. PCT/US25/56324, filed on Nov. 20, 2025, which claims the benefit of U.S. Provisional Application No. 63/722,867, filed on Nov. 20, 2024. This application claims the benefit of U.S. Provisional Application No. 63/722,867, filed on Nov. 20, 2024. The entire disclosure of each application referenced above is incorporated herein by reference.

### FIELD

The present disclosure relates to a reusable nut configured to be fixed within a hole in a component and to become part of assembly with the component.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A reusable nut is secured within a hole in the mating component so that a threaded stud attached to another component may be threaded into the nut to secure the other component to the mating component. To disassemble the other component from the mating component, the nut is rotated, which causes the threaded stud to back out of the nut. The nut may then be reused to secure a different component to the mating component by inserting a stud attached to the different component into the nut.

A reusable nut may be formed as two pieces or a single piece. A two-piece nut has one part that receives the threaded stud and another part, and the two parts are positioned on opposite sides of the hole in the mating component and secured to one another. In a one-piece nut, these two parts are formed together as a single body. A two-piece nut is shipped separately from the mating component. A one-piece nut may be part-of-assembly with the mating component, and the assembly may be shipped as one part, which may be a benefit to the entity receiving the mating component.

### SUMMARY

A nut according to the present disclosure is configured to be secured within a hole in a component. The nut includes an inner body, an outer body, and a pair of arms. In one example, the inner body has an inner surface and an outer surface, the inner surface defining a central aperture configured to receive a stud. The outer body has an upper end, a lower end, and an annular flange projecting radially outward from the lower end of the outer body. The arms connect the inner and outer bodies to one another while allowing the inner body to move relative to the outer body from a first position, in which a majority of the inner body is disposed outside of the outer body, to a second position, in which a majority of the inner body is disposed within the outer body. The inner body and the arms are insertable into the hole in the component when the inner body is in the first position and, when the inner body is moved from the first position to the second position after the arms are inserted through the hole in the component, the arms deform radially outward such that a portion of the component surrounding the hole is captured between the annular flange on the outer body and the arms.

In one aspect, the entire nut is formed as a single piece.

In one aspect, one end of each arm is attached to the lower end of the outer body, and the other end of each arm is attached to the outer surface of the inner body.

In one aspect, the nut further includes stud guides projecting radially inward from the inner surface of the inner body and, when the stud is inserted into the central aperture in the inner body, the stud guides engage the stud and thereby coaxially align the stud with the inner body.

In one aspect, the perimeters of the inner and outer bodies have a non-circular shape.

In one aspect, the inner body includes locking tabs that engage locking apertures in the outer body, and thereby lock the inner body within the outer body, when the inner body is in the second position.

In one aspect, the inner body has windows extending through the inner and outer surfaces thereof, and the locking tabs are disposed within the windows.

In one aspect, the locking tabs on the inner body flex radially inward as the inner body initially moves into the outer body, and the locking tabs return to their relaxed state when ramped protrusions thereon are aligned with and extend into the locking apertures in the outer body.

In one aspect, the inner surface of the inner body has stud engagement tabs projecting radially inward therefrom for engaging threads on the stud, and the locking tabs and the stud engagement tabs are connected to the rest of the inner body independent of one another.

In one aspect, the central aperture of the inner body is sized to engage threads on the stud when the stud is inserted into the central aperture and the nut is rotated relative to the stud.

In one aspect, each arm includes a lever connected between a first reduced thickness section and a second reduced thickness section.

In one aspect, as the nut is inserted into the hole in the component, the perimeter of the hole engages the lever and thereby causes the lever to pivot about the first and second reduced thickness sections toward the inner body, and when the lever is inserted completely through the hole, the lever pivots in the opposite direction and engages an underside surface of the component to inhibit withdrawal of the nut from the hole.

In one aspect, as the inner body is moved from the first position to the second position while the nut is inserted into the hole in the component, an underside surface of the component engages one end of the lever and thereby causes the lever to pivot about the first and second reduced thickness sections, and as the lever pivots, the arms pull the outer body into the hole in the component while pushing the inner body into the outer body.

In one aspect, the lever pivots to an orientation generally parallel to a longitudinal axis of the nut as the nut is inserted into the hole in the component, and the lever pivots to an orientation generally perpendicular to the longitudinal axis of the nut as the inner body is moved from the first position to the second position.

In one aspect, the inner body includes a pair of flanges projecting in opposite directions from the outer surface of the inner body and ramped protrusions disposed on the flanges and, when the inner body is moved from the first position to the second position, the ramped protrusions engage an inner surface of the outer body at the lower end thereof and thereby coaxially align the inner and outer bodies with one another.

In one aspect, the inner body further includes stud engagement tabs configured to engage an underside surface of a head of the stud and a stud stop configured to engage a top surface of the head.

In another example, the inner body has an inner surface and an outer surface, the inner surface defining a central aperture configured to receive a stud. The outer body having an upper end, a lower end, and a flange projecting outward from the lower end of the outer body. The arms connect the inner and outer bodies to one another while allowing the inner body to move relative to the outer body from a first position, in which a majority of the inner body is disposed outside of the outer body, to a second position, in which a majority of the inner body is disposed within the outer body. The inner body and the arms are insertable into the hole in the component when the inner body is in the first position and, when the inner body is moved from the first position to the second position after the arms are inserted through the hole in the component, the arms deform outward such that a portion of the component surrounding the hole is captured between the flange on the outer body and the arms.

In one aspect, the inner and outer bodies are shaped to transfer load from the outer body to the inner body when the outer body is rotated.

In one aspect, the inner body, the outer body, and the arms are part of a one-piece structure.

In one aspect, the inner surface of the inner body has stud engagement tabs projecting inward therefrom for engaging threads on the stud, the stud engagement tabs are also part of the one-piece structure and, when the inner body is in the second position and the stud is inserted into the central aperture of the inner body, the outer body is rotatable to cause the inner body to rotate, which unthreads the stud from the stud engagement tabs and thereby removes the stud from the nut.

In one aspect, the inner body includes locking tabs that engage locking apertures in the outer body and thereby lock the inner body within the outer body when the inner body is in the second position.

In one aspect, the locking tabs are connected to the rest of the inner body independent of the stud engagement tabs, and the stud engagement tabs are connected to the rest of the inner body independent of the locking tabs.

In one aspect, the central aperture of the inner body is sized to engage threads on the stud when the stud is inserted into the central aperture and the nut is rotated relative to the stud.

In one aspect, the inner body further includes stud engagement tabs configured to engage an underside surface of a head of the stud and a stud stop configured to engage a top surface of the head.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an assembly including a first example of a reusable nut according to the principles of the present disclosure fixed within a hole in a mating component, and a stud threaded into the nut;

FIG. 2 is a section view of the assembly of FIG. 1;

FIG. 3 is a perspective view of the nut of FIG. 1;

FIG. 4 is a top view of the nut of FIG. 1;

FIG. 5 is a sectioned perspective view of the nut of FIG. 1 taken along a line 5-5 shown in FIG. 4;

FIG. 5 is a sectioned perspective view of the nut of FIG. 1 taken along a line 6-6 shown in FIG. 4;

FIG. 7 is another top view of the nut of FIG. 1;

FIG. 8 is a bottom top view of the nut of FIG. 1;

FIG. 9 is a side view of the nut of FIG. 1;

FIG. 10 is a section view of the nut of FIG. 1;

FIG. 11 is a top view of the assembly of FIG. 1;

FIG. 12 is a section view of the assembly of FIG. 1 taken along a line 12-12 shown in FIG. 11; and

FIG. 13 is a section view of the assembly of FIG. 1 taken along a line 13-13 shown in FIG. 11;

FIGS. 14 through 19 are sectioned perspective views of the nut of FIG. 1 being inserted into a hole in the mating component of FIG. 1 and secured within the hole;

FIG. 20 is a perspective view of another example of a reusable nut according to the principles of the present disclosure;

FIG. 21 is a top view of the nut of FIG. 20;

FIG. 22 is a sectioned perspective view of the nut of FIG. 20 taken along a line 22-22 shown in FIG. 21;

FIG. 23 is a sectioned perspective view of the nut of FIG. 20 taken along a line 23-23 shown in FIG. 21;

FIG. 24 is a top view of an assembly including the nut of FIG. 20 fixed within a hole in a mating component, and a stud threaded into the nut;

FIG. 25 is a section view of the assembly of FIG. 24 taken along a line 25-25 shown in FIG. 24;

FIG. 26 is a section view of the assembly of FIG. 24 taken along a line 26-26 shown in FIG. 24;

FIG. 27 is a perspective view of another example of a reusable nut according to the principles of the present disclosure;

FIG. 28 is a top view of the nut of FIG. 27;

FIG. 29 is a top view of an assembly including the nut of FIG. 27 fixed within a hole in a mating component, and a stud inserted into the nut and fixed to another component;

FIG. 30 is a section view of the assembly of FIG. 29 taken along a line 30-30 shown in FIG. 29; and

FIG. 31 is a side view of the assembly of FIG. 29 with the stud and the other component separated from the nut and the mating component.

In the drawings, reference numbers may be reused to identify similar and/or identical elements.

### DETAILED DESCRIPTION

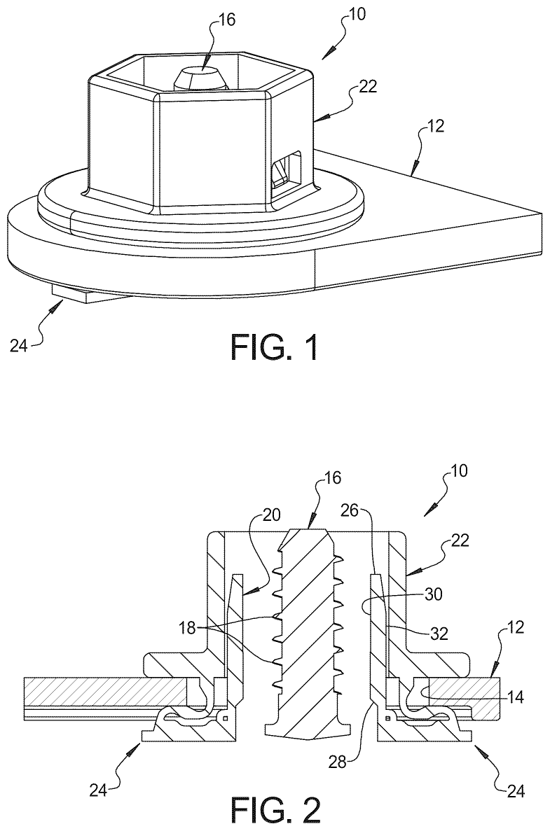

Referring now to FIGS. 1 and 2, a nut 10 is assembled to a mating component 12, such as a (e.g., plastic) flange or bracket, and is part of assembly (POA) with the mating component 12 for ease of installation into a final product such as a vehicle. The nut 10 is secured within a hole 14 in the mating component 12. The nut 10 is configured to receive a bolt or stud 16, such as a T5, T6, or M6 bolt or stud, and to engage threads 18 thereof. The stud 16 may be POA with another component, such as a piece of sheet metal, so that the nut 10 and the stud 16 join the other component to the mating component 12. In one example, the head of the stud 16 is welded to the other component.

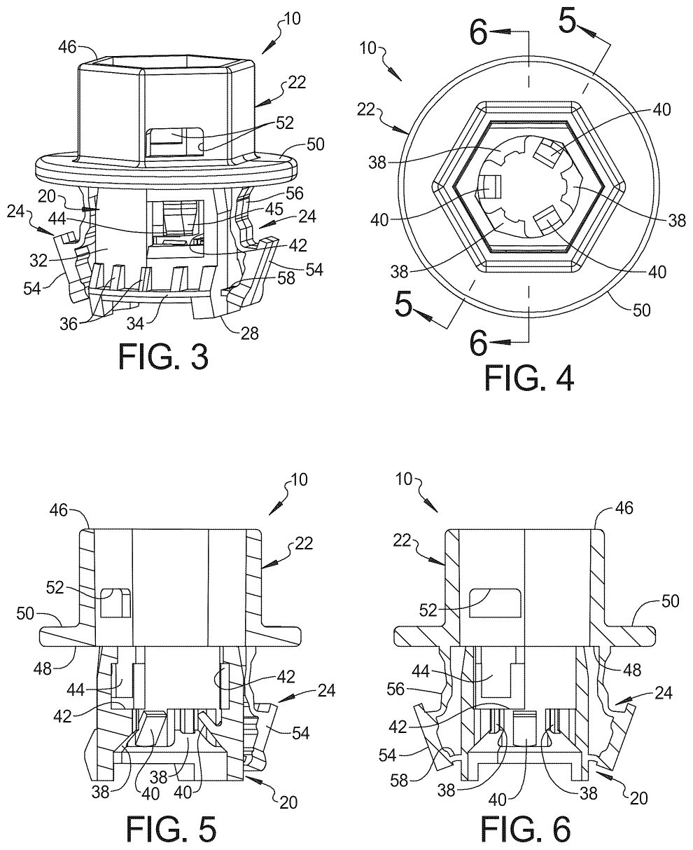

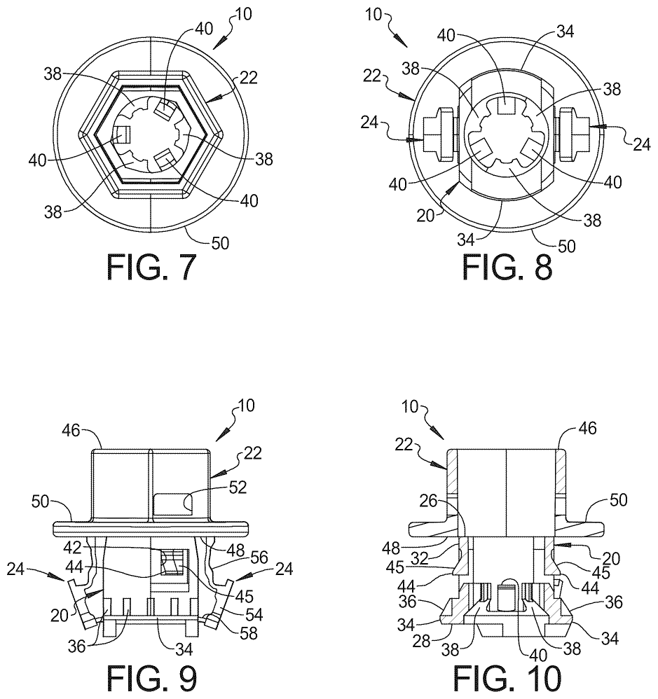

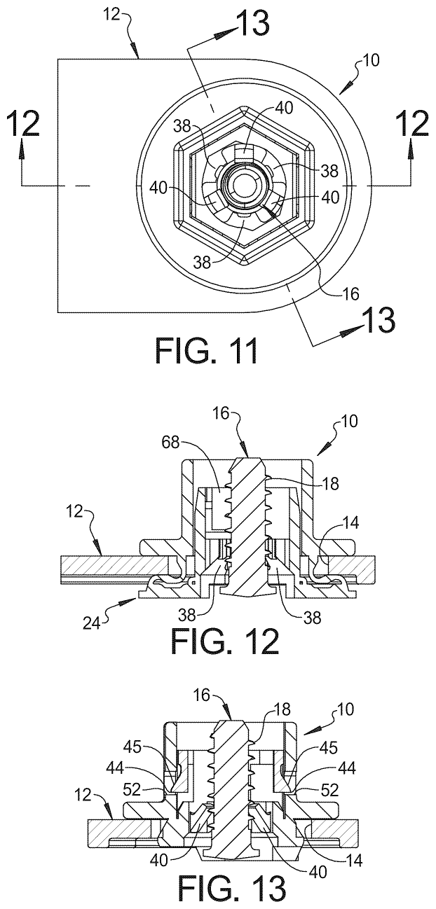

With additional reference to FIGS. 3 through 13, the nut 10 is formed (e.g., injection molded) from plastic (e.g., nylon) as a single piece. The nut 10 includes an inner polygonal body 20, an outer polygonal body 22, and a pair of arms 24 connecting the inner and outer polygonal bodies 20 and 22 to one another. The inner polygonal body 20 has an upper end 26, a lower end 28, an inner surface 30, and an outer surface 32. A pair of arc-shaped flanges 34 project in opposite directions from the outer surface 32, and a plurality of ramped protrusions 36 are disposed on the flanges 34. Three stud guides 38 project radially inward from the inner surface 30, and three stud engagement tabs 40 project upward and radially inward from the inner surface 30. A pair of openings or windows 42 extend through the inner and outer surfaces 30 and 32, and a pair of locking tabs 44 extend downward into the windows 42. Each locking tab 44 has a ramped protrusion 45 that projects radially outward therefrom.

The outer polygonal body 22 has an upper end 46, a lower end 48, and an annular flange 50 projecting radially outward from the lower end 48. A pair of locking apertures 52 extend radially through the outer polygonal body 22 adjacent to the lower end 48. One end of each arm 24 is attached to the lower end 48 of the outer polygonal body 22, and the other end of each arm 24 is attached to the outer surface 32 of the inner polygonal body 20 adjacent to the lower end 28 thereof. Each arm 24 includes a lever 54 connected between a first reduced thickness section 56 and a second reduced thickness section 58.

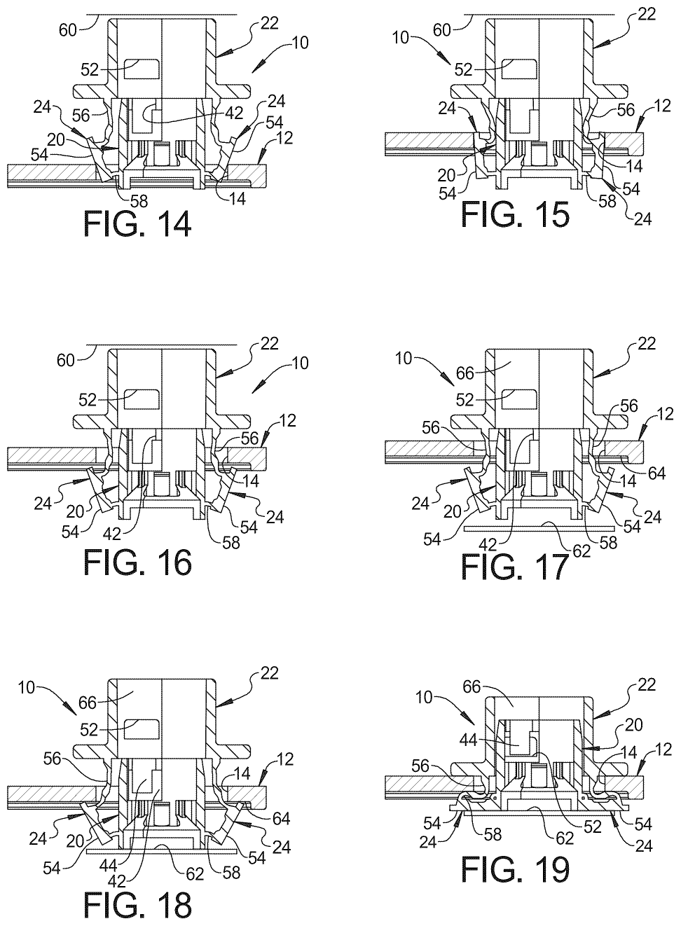

FIGS. 3 through 10 show the nut 10 before the nut 10 is assembled to the mating component 12. In this state, a majority (e.g., all) of the inner polygonal body 20 is disposed outside of the outer polygonal body 22, and the outermost diameter of the arms 24 is less than the diameter of the annular flange 50. FIGS. 14 through 19 illustrate assembly of the nut 10 to the mating component 12. FIGS. 14 through 19 are sectioned perspective views of the nut 10 and the mating component 12, as portions of the nut 10 and the mating component 12 have been omitted for illustration purposes.

In FIGS. 14 through 16, a tool 60 is used to push the nut 10 downward into the hole 14 in the mating component 12. As the nut 10 is inserted into the hole 14, the perimeter of the hole 14 engages the lever 54 of each arm 24. In turn, each lever 54 pivots about the first and second reduced thickness sections 56 and 58 to a generally vertical orientation (e.g., generally parallel to a longitudinal axis A-A of the nut 10) and moves radially inward toward the inner polygonal body 20. When the levers 54 are inserted completely through the hole 14, the levers 54 moves radially outward and return to their relaxed state.

Notably, when the levers 54 is inserted completely through the hole 14, the nut 10 is temporarily secured to the mating component 12 since the nut 10 cannot be pulled out of the hole 14 due to engagement between the upper ends of the levers 54 and the mating component 12. This feature provides more flexibility in the assembly process. For example, the nut 10 may be temporarily set to the mating component 12 in one station, and then permanently secured to the mating component 12 in another station.

In FIGS. 17 through 19, a tool 62 is used to push the inner polygonal body 20 upward into the outer polygonal body 22 and thereby permanently secure the nut 10 within the hole 14 in the mating component 12. Although not shown, another tool or object may be positioned above the nut 10 so that the nut 10 is compressed between the tool 62 and the other object or tool. As the inner polygonal body 20 is pushed upward, an underside surface 64 of the mating component 12 engages one end of each lever 54 and thereby causes the lever 54 to pivot about the first and second reduced thickness sections 56 and 58 to a generally horizontal orientation (e.g., generally perpendicular to the longitudinal axis A-A of the nut 10). In turn, the portion of the mating component 12 surrounding the hole 14 is captured between the annular flange 50 of the outer polygonal body 22 and the arms 24 as shown in FIGS. 2 and 12, thereby securing the nut 10 to the mating component 12. As the lever 54 pivots, the arms 24 pull the outer polygonal body 22 downward to the hole 14 in the mating component 12 while pushing the inner polygonal body 20 upward into the outer polygonal body 22. The ramped protrusions 36 on the inner polygonal body 20 engage an inner surface 66 of the outer polygonal body 22 at the lower end 48 thereof and thereby coaxially align the inner and outer polygonal bodies 20 and 22.

The locking tabs 44 on the inner polygonal body 20 flex radially inward as the inner polygonal body 20 initially moves into the outer polygonal body 22. The locking tabs 44 return to their relaxed state when the ramped protrusions 45 thereon are aligned with and extend into the locking apertures 52 in the outer polygonal body 22. The engagement between the locking tabs 44 and the locking apertures 52 inhibits the inner polygonal body 20 from moving back out of the outer polygonal body 22.

Once the nut 10 is secured within the hole 14 in the mating component 12 as shown in FIG. 12, the stud 16 may be inserted into the nut 10 by positioning a central aperture or bore 68 in the inner polygonal body 20 over the stud 16 and moving the mating component 12 toward the stud 16 so that the central aperture 68 receives the stud 16. As the stud 16 moves into the inner polygonal body 20, the stud guides 38 on the inner polygonal body 20 engage the stud 16 and thereby coaxially align the stud 16 with the inner polygonal body 20. This may be particularly beneficial during blind assembly of the other component with the stud 16 to the mating component 12 with the nut 10, when the insertion of the stud 16 into the central aperture 68 in the nut 10 is not visible to the assembler. In addition, the stud engagement tabs 40 on the inner polygonal body 20 engage the threads 18 on the stud 16 and thereby inhibit withdrawal of the stud 16. While this engagement is not shown in FIG. 2 due to the location of the section cut used to generate FIG. 2, this engagement is shown in FIG. 13.

The stud 16 may be removed from the nut 10 and the nut 10 may be reused with the stud 16 (or another stud) to attach another component to the mating component 12, which improves the serviceability of the assembly. To remove the stud 16 from the nut 10, a tool (e.g., a socket) is placed on the outer polygonal body 22 and rotated. Since the perimeters of the inner and outer polygonal bodies 20 and 22 are both polygonal (e.g., a closed plane figure bounded by straight lines), the inner polygonal body 20 rotates with the outer polygonal body 22 without subjecting the arms 24 to high stress. Rotation of the inner polygonal body 20 in a certain direction (e.g., counterclockwise) causes the stud 16 to unthread from the stud engagement tabs 40 and thereby moves the stud 16 downward out of the inner polygonal body 20. In the example shown, the perimeters of the inner and outer polygonal bodies 20 and 22 are both hexagonal. In various implementations, the perimeters of the inner and outer bodies 20 and 22 may have a polygonal shape other than hexagonal, such as square, pentagonal, or octagonal, or the perimeters of the inner and outer bodies 20 and 22 may have a continuous, non-circular shape other than polygonal, such as elliptical. In addition, the perimeters of the inner and outer bodies 20 and 22 may have the same non-circular shape or different non-circular shapes.

The inner and outer polygonal bodies 20 and 22 are shaped to transfer load from the outer polygonal body 22 to the inner polygonal body 20 when the outer polygonal body 22 is rotated, which ensures that the nut 10 does not fail when rotated to back out the stud 16 such that nut 10 is reusable. In contrast, some nuts or clips do not have inner and outer bodies that are shaped to transfer load from the outer body to the inner body. For example, KR102361302B1 describes a clip including an outer body and two elongated inner bodies that are not shaped to transfer load from the outer body to the inner bodies when the outer body is rotated. Thus, all of the load is transferred through legs that connect the inner and outer bodies to one another. As a result, the legs may fail when rotating the outer body to back a stud out of the clip, and therefore the clip may not be reusable.

The locking tabs 44, which lock the inner polygonal body 20 within the outer polygonal body 22, and the stud engagement tabs 40 are independently connected to the inner polygonal body 20 (a rigid body) and therefore flex independently of one another. In turn, when the stud 16 is subjected to an extraction force, any flexure of the stud engagement tabs 40 does not cause the locking tabs 44 to flex. Thus, the stud engagement tabs 40 fail before the locking tabs 44 disengage from the locking apertures 52 in the outer polygonal body 22. As a result, the nut 10 can withstand high extraction forces applied to the stud 16.

In contrast, in some nuts or clips, the locking features and the stud engagement features are on the same flexible body. For example, KR102361302B1 describes a clip including two flexible inner bodies that each have a locking feature locking the flexible inner bodies to an outer body and a stud engagement feature that engages a stud. Thus, when an extraction force is applied to the stud, any flexure of the stud engagement features may also cause the locking features to flex. In turn, the locking features may disengage from the outer body before the stud engagement features fail. As a result, the clip cannot withstand as high as stud extraction forces as the nut 10.

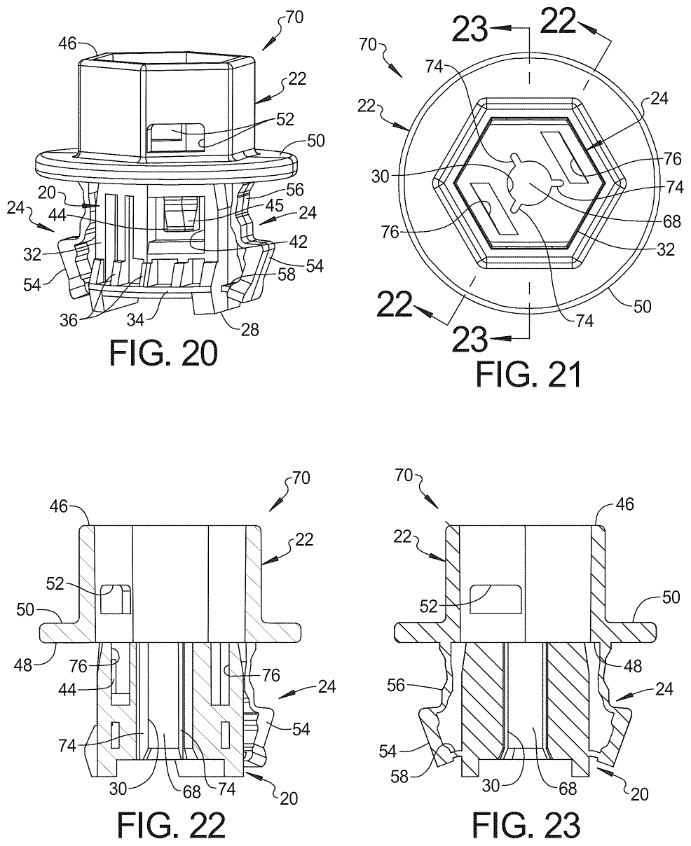

Referring now to FIGS. 20 through 26, a nut 70 is similar or identical to the nut 10 except that the nut 70 does not include the stud guides 38 or the stud engagement tabs 40 that project radially inward from the inner surface 30 of the inner polygonal boy 20. Instead, the central aperture 68 of the inner polygonal body 20 is sized to engage the threads 18 on the stud 16 when the stud 16 is inserted into the central aperture 68. When the stud 16 is partially inserted into the central aperture 68 of the inner polygonal body 20, the nut 70 may be rotated in a certain direction (e.g., clockwise) relative to the stud 16 by, for example, using a tool (e.g., a socket) placed on the outer polygonal body 22.

In one example, the central aperture 68 is threadless, and rotating the nut 70 relative to the stud 16 creates threads 72 in the inner surface 30 of the inner polygonal body 20 via engagement of the threads 18 on the stud 16 with the inner surface 30. In another example, the nut 70 is formed with the threads 72 in the inner surface 30 of the inner polygonal body 20, and rotating the nut 70 relative to the stud 16 simply engages the threads 72 of the nut 70 with the threads 18 on the stud 16. In either example, the engagement between the threads 72 of the nut 70 and the threads 18 of the stud 16 inhibits withdrawal of the stud 16 from the nut 70.

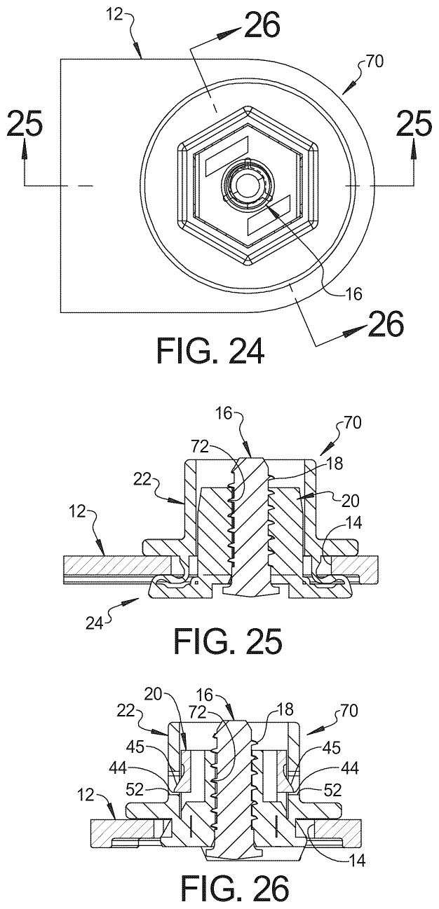

As best shown in FIG. 24, the inner polygonal body 24 defines three slots 74 and two cavities 76. The slots 74 extend radially outward from the central aperture 68 and are equally spaced apart from one another about the circumference of the central aperture 68. In addition, the slots 74 extend axially along the entire length of the central aperture 68. Furthermore, in the example shown, each slot 74 has a U-shaped cross section. The slots 74 provide space into which material of the inner polygonal body 24 may flow when the material is displaced as a result of the threads 18 on the stud 16 creating the threads 72 in the inner polygonal body 24. In addition, the slots 74 increase the flexibility of the inner polygonal body 24, which may reduce the force required to assemble the nut 70 to the mating component 12. In various implementations, the inner polygonal body 24 may define additional or fewer slots 74, or the slots 74 may be omitted entirely. In addition, each slot 74 may have a different cross-sectional shape, and the slots 74 may not be equally spaced apart from one another about the circumference of the central aperture 68.

The cavities 76 are spaced apart from the central aperture 68 and disposed on opposite sides thereof. In addition, the cavities 76 extend axially along about, or slightly more than, one-half of the length of the central aperture 68. Furthermore, in the example shown, each cavity 76 has a parallelogram-shaped cross section. The cavities 76 also increase the flexibility of the inner polygonal body 24. In addition, the cavities 76 reduce the amount of material in the nut 70, which reduces the mass of the nut 70 and the cost to produce the nut 70. In various implementations, the inner polygonal body 24 may define additional or fewer cavities 76, or the cavities 76 may be omitted entirely. In addition, each cavity 76 may have a different cross-sectional shape, and the cavities 76 may not be disposed on opposite sides of the central aperture 68.

The stud 16 may be removed from the nut 70 and the nut 70 may be reused with the stud 16 (or another stud) to attach another component to the mating component 12, which improves the serviceability of the assembly. To remove the stud 16 from the nut 70, the tool is placed on the outer polygonal body 22 and rotated. The direction in which the tool is rotated to remove the stud 16 from the nut 70 may of opposite of the direction in which the tool is rotated to create the threads 72 in the nut 70 and/or engage the threads 72 with the threads 18 on the stud 16.

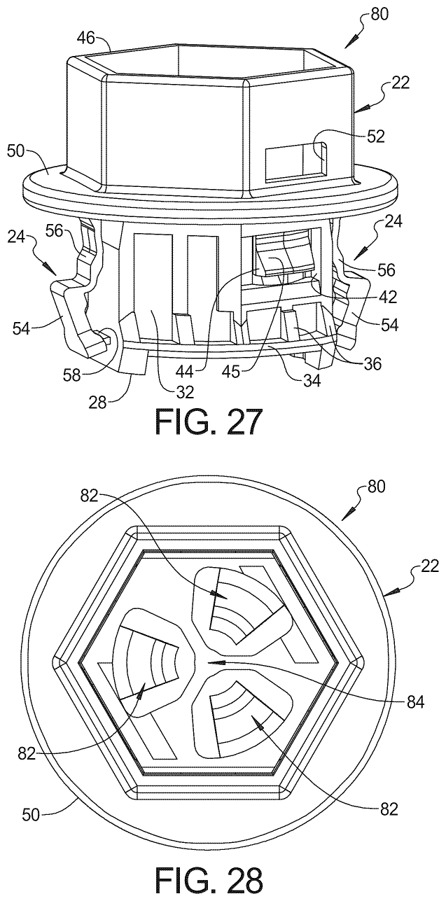

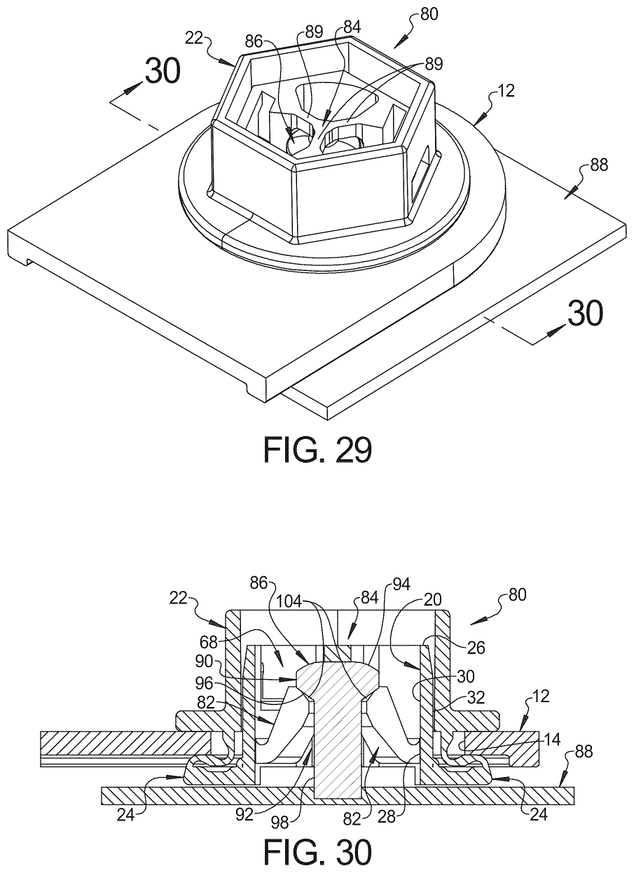

Referring now to FIGS. 27 through 31, a nut 80 is similar or identical to the nut 10 except that the nut 80 does not include the stud guides 38 or the stud engagement tabs 40 that project radially inward from the inner surface 30 of the inner polygonal body 20. Instead, the nut 80 includes stud engagement tabs 82 that project radially inward from the inner surface 30 of the inner polygonal body 20 at or adjacent to the lower end 28 thereof, and the nut 80 includes a stud stop 84 that projects radially inward from the inner surface of the inner polygonal body 20 at or adjacent to the upper end 26 thereof. The stud engagement tabs 82 and the stud stop 84 are configured to secure a stud 86 within the nut 80. The stud 86 may be POA with a panel or component 88 as shown so that the nut 80 and the stud 86 join the component 88 to the mating component 12. For example, the shank 92 of the stud 86 may be welded to the component 88.

The stud stop 84 includes three beams 89 that project radially inward from the inner surface 30 of the inner polygonal body 20 and join together at the center of the nut 80. The stud 86 includes a head 90 and a shank 92. The head 90 is disk shaped with an upper or top surface 94 and a lower or underside surface 96. The top surface 94 may be rounded as shown, and the underside surface 96 may be conically tapered as shown. The shank 92 is cylindrical with an outer radial surface 98.

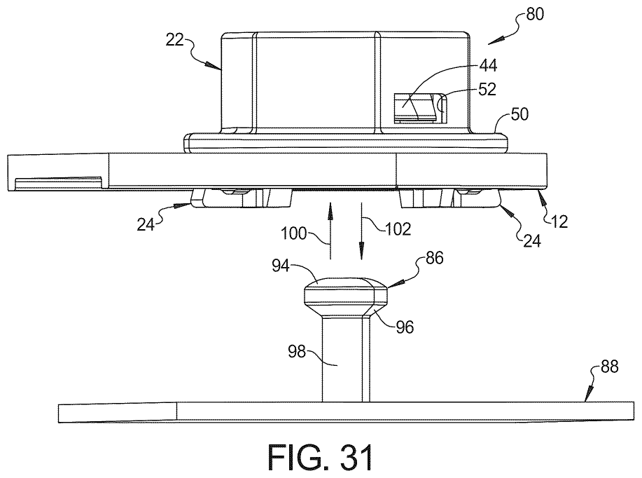

To secure the stud 86 within the nut 80, the stud 86 is inserted into the central aperture 68 of the inner polygonal body 20 in a first (axial) direction 100 shown in FIG. 31. When the top surface 94 of the head 90 of the stud 86 engages the stud engagement tabs 82 of the nut 80, the stud engagement tabs 82 deflect radially outward toward the inner surface 30 of the inner polygonal body 20. When the head 90 of the stud 86 is moved past the stud engagement tabs 82, the stud engagement tabs 82 return to their original position, or close to their original position, and engage the underside surface 96 of the head 90 as shown in FIG. 30. In turn, the stud engagement tabs 82 inhibit withdrawal of the stud 86 from the nut 80. The stud engagement tabs 82 may also engage the outer radial surface 98 of the shank 92.

When the stud engagement tabs 82 of the nut 80 engage the underside surface 96 of the head 90 of the stud 86, the stud stop 84 of the nut 80 engages the top surface 94 of the head 90 of the stud 86 and thereby stops or prevents the stud 86 from being inserted further into the central aperture 68 of the nut 80. In turn, the head 90 of the stud 86 is captured between the stud engagement tabs 82 of the nut 80 and the stud stop 84 of the nut 80, which securely holds the stud 86 within the nut 80 and inhibits movement of the stud 86 within the nut 80. The distance between the stud stop 84 and the stud engagement tabs 82 in the first direction 100 may be equal to or slightly greater than the height of the head 90 as shown so that the head 90 is held firmly between the stud engagement tabs 82 and the stud stop 84.

The stud 86 may be removed from the nut 80 and the nut 80 may be reused with the stud 86 (or another stud) to attach another component to the mating component 12, which improves the serviceability of the assembly. To remove the stud 86 from the nut 80, the stud 86 is withdrawn from the central aperture 68 of the inner polygonal body 20 in a second direction 102 opposite of the first direction 100. The stud engagement tabs 82 have upper surfaces 104 that engage the underside surface 96 of the head 90 of the stud 86, and the upper surfaces 104 may be tapered or sloped as shown to reduce the force required to withdraw the stud 86 from the central aperture 68 of nut 80.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “and/or” includes any and all combinations of one or more of the associated listed items. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A nut configured to be secured within a hole in a component, the nut comprising:
an inner polygonal body having an inner surface and an outer surface, the inner surface defining a central aperture configured to receive a stud;
an outer polygonal body having an upper end, a lower end, and an annular flange projecting radially outward from the lower end of the outer polygonal body; and
a pair of arms connecting the inner and outer polygonal bodies to one another while allowing the inner polygonal body to move relative to the outer polygonal body from a first position, in which a majority of the inner polygonal body is disposed outside of the outer polygonal body, to a second position, in which a majority of the inner polygonal body is disposed within the outer polygonal body, wherein the inner polygonal body and the arms are insertable into the hole in the component when the inner polygonal body is in the first position and, when the inner polygonal body is moved from the first position to the second position after the arms are inserted through the hole in the component, the arms deform radially outward such that a portion of the component surrounding the hole is captured between the annular flange on the outer polygonal body and the arms.

2. The nut of claim 1 wherein the entire nut is formed as a single piece.

3. The nut of claim 1 wherein one end of each arm is attached to the lower end of the outer polygonal body, and the other end of each arm is attached to the outer surface of the inner polygonal body.

4. The nut of claim 1 further comprising stud guides projecting radially inward from the inner surface of the inner polygonal body, wherein when the stud is inserted into the central aperture in the inner polygonal body, the stud guides engage the stud and thereby coaxially align the stud with the inner polygonal body.

5. The nut of claim 1 wherein the inner polygonal body includes locking tabs that engage locking apertures in the outer polygonal body, and thereby lock the inner polygonal body within the outer polygonal body, when the inner polygonal body is in the second position.

6. The nut of claim 5 wherein the inner polygonal body has windows extending through the inner and outer surfaces thereof, and the locking tabs are disposed within the windows.

7. The nut of claim 5 wherein the locking tabs on the inner polygonal body flex radially inward as the inner polygonal body initially moves into the outer polygonal body, and the locking tabs return to their relaxed state when ramped protrusions thereon are aligned with and extend into the locking apertures in the outer polygonal body.

8. The nut of claim 5 wherein the inner surface of the inner polygonal body has stud engagement tabs projecting radially inward therefrom for engaging threads on the stud, and the locking tabs and the stud engagement tabs are connected to the rest of the inner polygonal body independent of one another.

9. The nut of claim 1 wherein the central aperture of the inner polygonal body is sized to engage threads on the stud when the stud is inserted into the central aperture and the nut is rotated relative to the stud.

10. The nut of claim 1 wherein each arm includes a lever connected between a first reduced thickness section and a second reduced thickness section.

11. The nut of claim 10 wherein, as the nut is inserted into the hole in the component, the perimeter of the hole engages the lever and thereby causes the lever to pivot about the first and second reduced thickness sections toward the inner polygonal body, and when the lever is inserted completely through the hole, the lever pivots in the opposite direction and engages an underside surface of the component to inhibit withdrawal of the nut from the hole.

12. The nut of claim 10 wherein, as the inner polygonal body is moved from the first position to the second position while the nut is inserted into the hole in the component, an underside surface of the component engages one end of the lever and thereby causes the lever to pivot about the first and second reduced thickness sections, and as the lever pivots, the arms pull the outer polygonal body into the hole in the component while pushing the inner polygonal body into the outer polygonal body.

13. The nut of claim 10 wherein the lever pivots to an orientation generally parallel to a longitudinal axis of the nut as the nut is inserted into the hole in the component, and the lever pivots to an orientation generally perpendicular to the longitudinal axis of the nut as the inner polygonal body is moved from the first position to the second position.

14. The nut of claim 1 wherein the inner polygonal body includes a pair of flanges projecting in opposite directions from the outer surface of the inner polygonal body and ramped protrusions disposed on the flanges and, when the inner polygonal body is moved from the first position to the second position, the ramped protrusions engage an inner surface of the outer polygonal body at the lower end thereof and thereby coaxially align the inner and outer polygonal bodies with one another.

15. The nut of claim 1 wherein the inner polygonal body further includes stud engagement tabs configured to engage an underside surface of a head of the stud and a stud stop configured to engage a top surface of the head.

16. A nut configured to be secured within a hole in a component, the nut comprising:
an inner body having an inner surface and an outer surface, the inner surface defining a central aperture configured to receive a stud;
an outer body having an upper end, a lower end, and a flange projecting outward from the lower end of the outer body, wherein the inner and outer bodies are shaped to transfer load from the outer body to the inner body when the outer body is rotated; and
a pair of arms connecting the inner and outer bodies to one another while allowing the inner body to move relative to the outer body from a first position, in which a majority of the inner body is disposed outside of the outer body, to a second position, in which a majority of the inner body is disposed within the outer body, wherein the inner body and the arms are insertable into the hole in the component when the inner body is in the first position and, when the inner body is moved from the first position to the second position after the arms are inserted through the hole in the component, the arms deform outward such that a portion of the component surrounding the hole is captured between the flange on the outer body and the arms.

17. The nut of claim 16 wherein the perimeters of the inner and outer bodies have a non-circular shape.

18. The nut of claim 16 wherein the inner body, the outer body, and the arms are part of a one-piece structure.

19. The nut of claim 18 wherein the inner surface of the inner body has stud engagement tabs projecting inward therefrom for engaging threads on the stud, the stud engagement tabs are also part of the one-piece structure and, when the inner body is in the second position and the stud is inserted into the central aperture of the inner body, the outer body is rotatable to cause the inner body to rotate, which unthreads the stud from the stud engagement tabs and thereby removes the stud from the nut.

20. The nut of claim 19 wherein the inner body includes locking tabs that engage locking apertures in the outer body and thereby lock the inner body within the outer body when the inner body is in the second position.

21. The nut of claim 20 wherein the locking tabs are connected to the rest of the inner body independent of the stud engagement tabs, and the stud engagement tabs are connected to the rest of the inner body independent of the locking tabs.

22. The nut of claim 16 wherein the central aperture of the inner body is sized to engage threads on the stud when the stud is inserted into the central aperture and the nut is rotated relative to the stud.

23. The nut of claim 16 wherein the inner body further includes stud engagement tabs configured to engage an underside surface of a head of the stud and a stud stop configured to engage a top surface of the head.
